(19) United States
(12) Patent Application Publication
(10) Pub. No.: US 2004/0180175 A1
(43) Pub. Date: Sep. 16, 2004

(54) Ornament having an annular structure

(76) Inventor: Attilio Zanetti, Torri Del Benaco (IT)

Correspondence Address: MODIANO & ASSOCIATI, Via Meravigli, 16, MILANO, 20123, IT

(21) Appl. No.: 10/793,727

(22) Filed: Mar. 8, 2004

(30) Foreign Application Priority Data
Mar. 14, 2003 (IT) VR2003U000011

(51) Int. Cl. B32B 3/02

(52) U.S. Cl. 428/66.6

(57) ABSTRACT

An ornament, particularly having an annular structure, comprising at least two jaws, which rotate on a plane that is substantially perpendicular to the fitting axis and support, substantially at their respective free end portions, closure elements that comprise a portion that supports at least one engagement tooth and is supported by a first one of the two free ends and at least one abutment seat for the engagement tooth that is supported by the other one of the two free ends; the closure elements comprise a release button that is kinematically connected to the at least one engagement tooth or to the at least one seat and disengages, under the actuation of the user, the at least one engagement tooth from the at least one closure seat.

### BACKGROUND OF THE INVENTION

Currently, ornaments such as for example bracelets or necklaces, particularly jewelry, costume jewelry and the like, are provided with closure devices that allow them to have an annular structure during use.

These closure devices allow the ornament to pass from an open condition, generally used to fit the bracelet around the wrist or the necklace around the neck of the user, to a closed condition, which allows to obtain an annular structure that has the dimensions chosen by the user.

Although there are many types of closure device, they are not free from drawbacks.

Many closure devices currently in use in fact are not reliable, since they can be activated, consequently passing from the closed condition to the open condition, as a consequence of accidental impacts.

In many cases, moreover, such closure devices do not allow adequate adjustment of the dimensions of the annular structure.

### SUMMARY OF THE INVENTION

The aim of the present invention is to provide an ornament having an annular structure that is capable of eliminating or in any case substantially reducing the drawbacks noted above in known types.

Within this aim, an object of the invention is to provide an ornament, particularly having an annular structure, that has a reliable closure device so as to avoid risks of accidental opening while wearing the ornament.

Another object of the invention is to provide an ornament that allows extraction to occur only by intentional action of the user.

Another object of the present invention is to provide an ornament having a closure device that is practical and functional both in terms of manufacture and in terms of use, without this having a negative effect on the aesthetic and ornamental characteristics of the item.

Another object of the present invention is to provide an ornament, particularly having an annular structure, that has a low production cost, so as to be advantageous also from the economical standpoint.

This aim and these and other objects that will become better apparent hereinafter are achieved by an ornament, particularly having an annular structure, comprising at least two jaws, which rotate on a plane that is substantially perpendicular to the fitting axis and support, substantially at respective free end portions thereof, closure means that comprise a portion that supports at least one engagement tooth and is supported by a first one of said two free ends and at least one abutment seat for said engagement tooth that is supported by a second one of said two free ends, said closure means comprising a release button that is kinematically connected to said at least one engagement tooth or to said at least one seat and is adapted to disengage, under the actuation of the user, said at least one engagement tooth from said at least one closure seat.

Advantageously, an ornament according to the invention comprises an opening key that can be inserted between said free end portions and is suitable to disengage said at least one tooth from said at least one seat.

Conveniently, an ornament according to the invention is characterized in that said at least one seat is supported by a flexible lamina that is supported at an engagement portion of said other free end.

### BRIEF DESCRIPTION OF THE DRAWINGS

Further characteristics and advantages of the invention will become better apparent from the present detailed description of some currently preferred examples of embodiment, given merely by way of non-limiting example with reference to the accompanying drawings, wherein:

FIG. 1 is a side elevation view of an ornament according to the invention;

FIG. 2 is a sectional view, taken along the line II-II of FIG. 1, of the ornament according to the invention;

FIG. 3 is a sectional view, taken along the line III-III of FIG. 1, of the ornament according to the invention;

FIG. 4 is a sectional view, taken along the line IV-IV of FIG. 1, of the ornament according to the invention;

FIG. 5 is an enlarged-scale side elevation view of the free ends of the ornament, in which the locking flap has been omitted for the sake of greater clarity;

FIG. 6 is a perspective view of the free ends of the ornament according to the invention, with the opening key partially inserted;

FIG. 7 is a perspective view of an opening key;

FIG. 8 is a side elevation view of the closure means in the engaged condition; and

FIG. 9 is a side elevation view of the closure means in the disengaged condition.

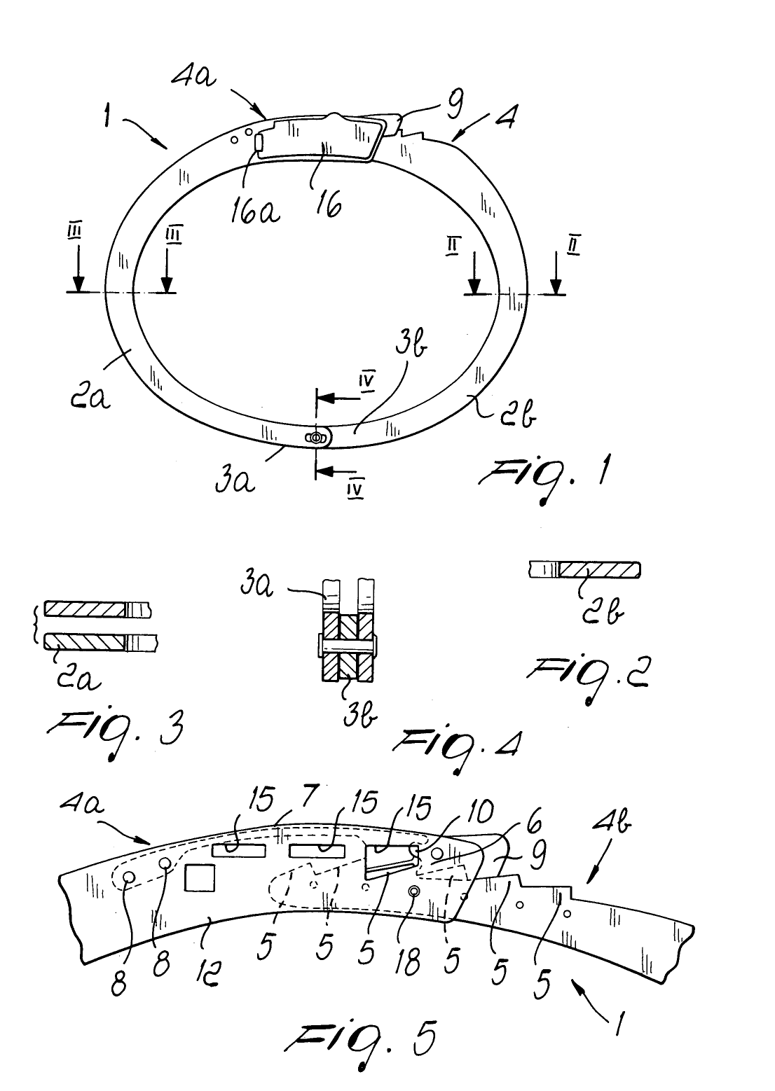

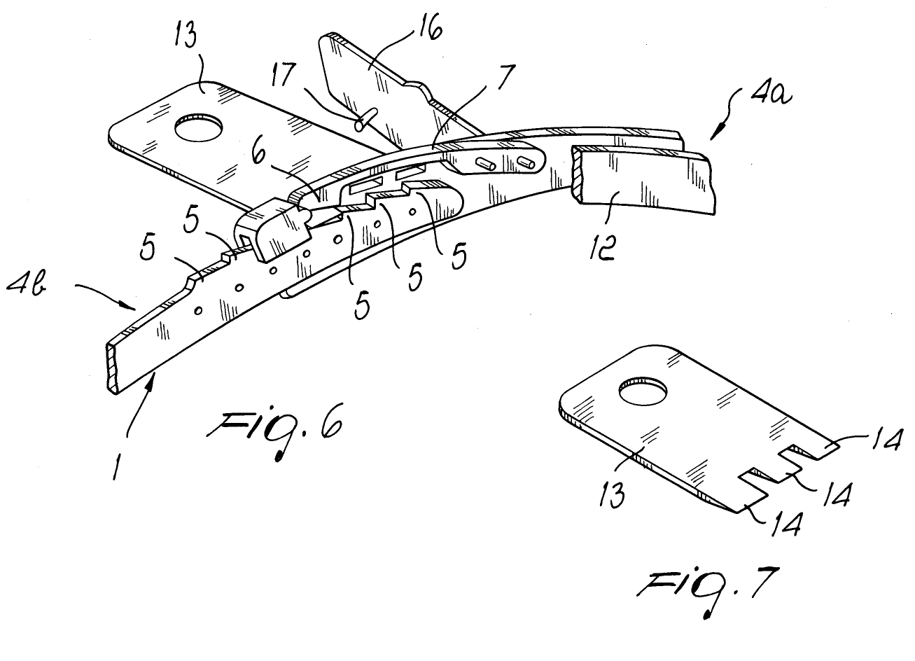

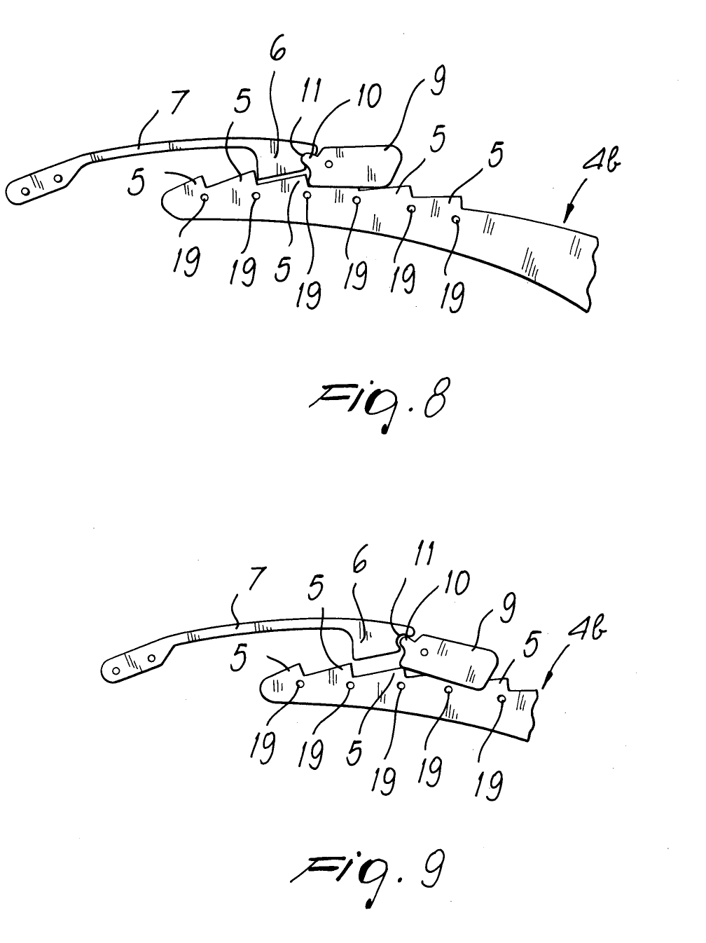

### DESCRIPTION OF THE PREFERRED EMBODIMENTS

In the examples of embodiment that follow, individual characteristics, given in relation to specific examples, may actually be interchanged with other different characteristics that exist in other examples of embodiment.

Moreover, it is noted that anything found to be already known during the patenting process is understood not to be claimed and to be the subject of a disclaimer.

With reference to the above figures, an ornament particularly having an annular structure, according to the invention, generally designated by the reference numeral 1, comprises at least two jaws 2a and 2b which rotate on a plane that is substantially perpendicular to the fitting axis.

Advantageously, as shown in particular in FIG. 1, the two jaws 2a and 2b are pivoted at a respective pivoting end thereof 3a and 3b, so that the free ends 4a and 4b of the jaws 2a and 2b can be moved apart or mutually closer and optionally connected in order to form an annular structure suitable for wearing the ornament.

For this purpose, the free ends 4a and 4b have closure means that are constituted, in the illustrated example, by at least one engagement tooth 5 (supported for example by the free end 4b of the jaw 2b) and by at least one respective closure seat 6 that is supported by the free end 4a of the other jaw 2a.

Conveniently, the closure seat 6 is constituted by a pawl-shaped protrusion, which is supported by a flexible lamina 7.

Such flexible lamina 7 is anchored appropriately (for example by means of two fixing pins 8) to an engagement portion of the free end 4a of the jaw 2a.

Conveniently, the flexible lamina 7 is made of elastically deformable material, such as for example spring steel.

Advantageously, as shown, the free end 4b of the jaw 2b has a male shape so as to have a plurality of engagement teeth 5 arranged in a sawtooth configuration.

It is evident that by moving mutually closer the free ends 4a and 4b, an engagement tooth 5 is made to engage the closure seat 6, optionally adjusting the width of the fit according to the tooth 5 that is made to engage the closure seat 6.

The flexible lamina 7 allows the closure seat 6 that it supports to be kept pressed against the respective tooth 5, and at the same time the shape of the tooth 5 and of the closure seat 6 prevents the mutual spacing of the jaws 2a and 2b and accordingly the opening of the ornament.

According to the invention, the ornament 1 has a release button 9 that is articulated, for example as shown in the figures, to the free end 4a of the jaw 2a.

In particular, the release button 9 can be supported so that it can rotate, for example by means of a pivot 9a, by a portion of the free end 4a of the jaw 2a.

The release button 9, in the illustrated example, is kinematically connected to the closure seat 6, for example by means of an engagement detent 10 that is designed to be accommodated within a complementarily shaped portion 11 supported by said closure seat 6.

Again with reference to the figures, the free end 4a has two side walls 12 for guiding the lamina 7, between which the free end 4b, which is optionally sawtooth-shaped, can enter.

Conveniently, said side walls 12 can act as supports for the pivot 9a and therefore for the release button 9.

According to the invention, the ornament 1 is provided with an opening key 13, which can be inserted between the free ends 4a and 4b so as to disengage the closure seat 6 from the respective tooth 5, consequently allowing to move mutually apart the jaws 2a and 2b.

The opening key 13 may have any shape suitable for the purpose, and in the illustrated example has three engagement laminas 14 that are designed to be inserted within respective slots 15 formed in at least one of the side walls 12.

At least one of the engagement laminas 14, by interposing itself between the flexible lamina 7 and the free end 4b, tends to move mutually apart the two elements, accordingly disengaging the closure seat 6 from the respective engagement tooth 5.

Advantageously, as can be noticed with particular reference to FIG. 6, the ornament 1 according to the invention can be provided, furthermore, with a locking flap 16 that is pivoted, at a pivoting end 16a, to the free end 4a and in particular to one of the two side walls 12.

Said locking flap 16 supports a pivot 17, which protrudes along a direction that is substantially perpendicular to the plane of arrangement of said locking flap 16.

A first abutment opening 18 is formed at the side wall 12 to which the closure flap 16 is pivoted; said opening is designed to be aligned with a second abutment opening 19 that is supported by the second free end 4b. Actually, if the second free end 4b is sawtooth-shaped, on said second end there are advantageously a plurality of second abutment openings 19, each of which is designed to be aligned with the first abutment opening 18, depending on which of the engagement teeth 5 engages the closure seat 6.

Operation of the invention is evident from what has been described above.

In particular, if one wishes to wear an ornament 1 according to the invention, the free ends 4a and 4b of the two jaws 2a and 2b are moved mutually apart and then moved mutually closer again once the ornament, for example a bracelet, has been fitted around the wrist.

By moving mutually closer the free ends 4a and 4b, the abutment seat 6 is moved so as to engage one of the engagement teeth 5, so that the annular size of the ornament is the one that best suits the user.

If the ornament 1 is provided with the locking flap, said flap is also closed.

If one wishes to open the ornament, after opening the closure flap (if the ornament has one) it is possible to disengage the engagement tooth 5 from the abutment seat 6.

To perform this operation, the user can, in a fully equivalent manner, act on the release button, for example by pressing with one finger, or insert the opening key between the two free ends, and in particular between the sawtooth-shaped portion and the flexible lamina.

It has been found that the ornament particularly having an annular structure according to the invention fully achieves the intended aim and objects.

Moreover, all the details may be replaced with other technically equivalent elements.

The two jaws 2a and 2b may have any shape and configuration according to the aesthetic and ornamental requirements.

Moreover, the opening key may optionally be connected or connectable to a portion of the ornament 1, for example by means of a chain or the like.

Characteristics that are indicated as advantageous, convenient or the like may also be omitted or replaced by equivalents.

The materials and the dimensions may be various according to requirements. The disclosures in Italian Utility Model Application No. VR2003U000011 from which this application claims priority are incorporated herein by reference.

What is claimed is:

1. An ornament, particularly having an annular structure, comprising at least two jaws, which rotate on a plane that is substantially perpendicular to a fitting axis and support, substantially at respective free end portions thereof, closure means that comprise a portion that supports at least one engagement tooth and is supported by a first one of said two free ends and at least one abutment seat for said engagement tooth that is supported by a second one of said two free ends, said closure means comprising a release button that is kinematically connected to said at least one engagement tooth or to said at least one seat and is adapted to disengage, under the actuation of the user, said at least one engagement tooth from said at least one seat.

2. The ornament according to claim 1, further comprising an opening key that can be inserted between said at least one tooth and said at least one seat and is adapted to disengage said at least one tooth from said at least one seat.

3. The ornament according to claim 1, wherein said at least one seat is supported by a flexible lamina that is supported at a portion of said second free end.

4. The ornament according to claim 3, wherein said at least one seat comprises a pawl-like protrusion that is supported by said flexible lamina.

5. The ornament according to claim 1, wherein said release button is pivoted to said free end and is adapted, if pressed, to cause the disengagement of said at least one engagement tooth with respect to said seat.

6. The ornament according to claim 1, wherein said first free end comprises a male-shaped portion, which forms a plurality of sawtooth elements.

7. The ornament according to claim 2, wherein said second free end comprises two side walls for guiding said first free end.

8. The ornament according to claim 7, comprising locking means that comprise a pivot that is supported by a locking flap that is pivoted to said second end, a first abutment opening that passes through at least one of said two side walls and at least one second abutment opening that is supported by said male-shaped end and is designed to be aligned with said first opening when said at least one engagement tooth abuts against said seat, said pivot being inserted, under the actuation of the user, within said first opening and said at least one second aligned opening.

9. The ornament according to claim 8, wherein at least one of said side walls comprises at least one slot for the insertion of said opening key.
